(19) United States
(12) Patent Application Publication
(10) Pub. No.: US 2024/0426313 A1
(43) Pub. Date: Dec. 26, 2024

(54) IMPELLER FOR A RADIAL FAN

(71) Applicant: ebm-papst Mulfingen GmbH & Co. KG, Mulfingen (DE)

(72) Inventors: Erhard GRUBER, Satteldorf (DE); Oliver HAAF, Kupferzell (DE); Reinhard STROHMEIER, Neuenstein (DE); Sebastian RHEIN, Bad Mergentheim (DE); Eugen NASARKIN, Neckarsulm (DE)

(21) Appl. No.: 18/747,790

(22) Filed: Jun. 19, 2024

(30) Foreign Application Priority Data
Jun. 21, 2023 (DE) 102023116229.2

(51) Int. Cl. F04D 29/28; F04D 17/16

(52) U.S. Cl. CPC F04D 29/282; F04D 17/16

(57) ABSTRACT

Impeller 1 of a radial fan for conveying a gaseous fluid includes a bottom plate 2, and a cover plate 3. The cover plate 3 is spaced apart from the bottom plate 2 in the axial direction 15 of the impeller 1. The cover plate 3 and/or the bottom plate 2 have/has at least one impressed bead 5, and a plurality of blades 7. The at least one blade 7 is arranged between the cover plate 3 and the bottom plate 2 and is fastened in the region of and over the profile of at least one bead 5A surface profile of the bead 5 follows a surface profile of the blade 7 fastened to the bead 5, at least in an envelope, such that a conveying effect of the bead 5 corresponds at least to a conveying effect of a blade surface 8 which is reduced because of the bead 5.

### CROSS-REFERENCE TO RELATED APPLICATION

This Application claims priority to German Application No. 102023116229.2, filed Jun. 21, 2023; the contents of which is hereby incorporated by reference in their entirety.

### BRIEF DESCRIPTION OF THE DRAWINGS

FIG. 1 shows a perspective view of an impeller, in one example.

FIG. 2 shows a further perspective view of the impeller, in one example.

FIG. 3 shows a further perspective view of the impeller, in one example.

FIG. 4 shows a top view of a bottom plate, in one example.

FIG. 5 shows a top view of a bottom plate with blades, in one example.

FIG. 6 shows a top view of a bottom plate with blades, in one example.

### DETAILED DESCRIPTION

The present disclosure relates to the technical field of impellers for radial fans for conveying a gaseous fluid.

Impellers for radial fans are already known to a person skilled in the art from the prior art.

The document EP 2 846 046 A1 discloses, for example, a fan impeller for conveying a gaseous fluid, having a plurality of blades which are arranged at a constant angular pitch in an annular spatial volume about an axis of rotation and which are each fixed by their axial opposite end regions to a carrier means. A characteristic feature is that at least one blade has an edge region, in particular encircling in a frame-like manner, and at least one inner region surrounded by the edge region, wherein between the edge region and the inner region at least one bead is formed along an at least L-shaped, preferably U-shaped, in particular encircling profile curve, and/or wherein the edge region of a first blade surface is determined and the inner region of a second blade surface is determined, which second blade surface is arranged and/or formed geometrically differently from the first blade surface.

Furthermore, impellers of radial fans are known that comprise flat bottom plates and cover plates on which blades are fastened.

It is always a disadvantage here that, for example, an increase in the rotational speed stability is accompanied by a loss of the conveying effect of the impeller or an increase in the conveying effect negatively influences the rotational speed stability.

A technical object of the present disclosure is therefore to propose an improvement to the rotational speed stability while the conveying effect of an impeller of a radial fan remains at least the same.

The technical object is achieved by means of subject matter having the technical features according to the independent claim. Advantageous embodiments are the subject matter of the dependent claims, the description and the drawings.

Within the context of the present disclosure, it is provided that the proposed refinements may relate to all of the components of the impeller, which is manufactured for example from metal, but also only to individual components of the impeller. Within the context of the present disclosure, the components of an impeller should be understood as meaning a cover plate, bottom plate and blades. In addition, within the context of the present disclosure, it is provided that the proposed refinements may relate to all of the blades of an impeller, but also only to individual blades of an impeller. In other words, a refinement of only one of the aforementioned components may be advantageous, but a refinement of all of the components achieves the most advantages.

Within the context of the present disclosure, a width of the bead should be understood as meaning a width in a top view in an axial viewing direction of the impeller.

Furthermore, within the context of the present disclosure, a height of the bead should be understood as meaning a positive or negative height in the axial direction, starting from the cover plate and/or bottom plate, of the impeller.

According to one aspect, a technical object of the present disclosure is achieved by means of an impeller of a radial fan for conveying a gaseous fluid, the impeller comprising a bottom plate, a cover plate, wherein the cover plate is spaced apart from the bottom plate in the axial direction of the impeller, wherein the cover plate and/or the bottom plate have/has at least one impressed bead, in particular a plurality of impressed beads, a plurality of blades, wherein at least one blade is arranged between the cover plate and the bottom plate and is fastened in the region of and over the profile of at least one bead, wherein a surface profile of the bead follows a surface profile of the blade fastened to the bead, at least in an envelope, such that a conveying effect of the bead corresponds at least to a conveying effect of a blade surface which is reduced because of the bead.

Within the context of the present disclosure, an envelope may be understood, for example, as a contour or a surface surrounding the object which it encloses, such as the blade, for example.

This can advantageously firstly enable the blade to be shortened and at the same time the bottom plate to be reinforced. For example, beads may be impressed in the cover plate and/or bottom plate in the direction of the blades. The blade then sits on, or at, or in these beads, and is shortened as a result and adapted in shape, as a result of which lever ratios occurring during operation of the impeller can be improved, and the transition between blade and cover plate and/or bottom plate can be made less abrupt. The stresses occurring throughout the impeller during operation of the impeller can thus be reduced. In particular, stresses introduced by the blades into the cover plate and/or bottom plate can be advantageously reduced. The strength of the impeller can thus be increased and higher rotational speeds or higher peripheral speeds can thus be achieved.

In addition, costs can be reduced and greater flexibility in the design of an impeller can be made possible.

In a technically advantageous embodiment of the impeller, it is provided that the blade is arranged on the bead, in particular at the bead, preferably in the bead.

This can additionally increase the flexibility in the production of an impeller.

In a further technically advantageous embodiment of the impeller, it is provided that the bead is impressed along a contour of the blade, in particular along a contour of an edge region of the blade that lies against the cover plate or against the bottom plate.

This can advantageously additionally improve the stability and the strength of the impeller.

In addition, in a further technically advantageous embodiment of the impeller, it is provided that a height of the bead varies, and in particular increases, in the radial direction of the impeller.

This means that special requirements when using the impeller can be taken into account and the production can be correspondingly adapted in order to additionally increase the strength of the impeller.

In addition, it is provided, in a further technically advantageous embodiment of the impeller, that the height of the bead corresponds to a tenth, in particular a fifteenth, in particular a twentieth, preferably at most a fiftieth, of a distance between the bottom plate and the cover plate.

This can additionally also increase the production possibilities, taking into account given use requirements.

Furthermore, it is provided, in a further technically advantageous embodiment of the impeller, that a width of the bead varies, and in particular increases, in the radial direction of the impeller.

This can likewise additionally permit an increase in the stability and strength of the impeller and afford flexible production possibilities for given requirements when using the impeller.

In addition, it is provided, in a further technically advantageous embodiment of the impeller, that the bead is formed interrupted, in particular is only formed partially, in the radial direction of the impeller.

This can additionally afford advantageous possibilities for the manufacturing and during the use of the impeller.

In addition, in a further technically advantageous embodiment of the impeller, it is provided that the bead, in particular a flank of the bead, is formed parallel or profiled to the blade, preferably to a contour of the blade.

In other words, the shape of the bead may be parallel to the blade, but it may also have a profile shape, for example in an arrangement in the center of the blade, which can additionally have an advantageous effect on the stability and strength of the impeller.

Furthermore, it is provided, in a further technically advantageous embodiment of the impeller, that the bead has a pressure-side profile, in particular a pressure-side contour profile, which deviates from a suction-side profile of the bead, in particular suction-side contour profile of the bead.

This can advantageously also permit production which is more flexible, to improve the stability and strength of the impeller.

In addition, it is provided, in a further technically advantageous embodiment of the impeller, that the bead, in particular a bead outlet of the bead, has a, preferably partially, continuously curved transition into the bottom plate and/or into the cover plate.

In regions subjected to heavy loads, this can advantageously contribute to additional stability.

In addition, it is provided, in a further technically advantageous embodiment of the impeller, that a fastening of the blade is formed by means of a welded and/or a lashed and/or screwed and/or riveted and/or glued and/or calked connection, wherein the fastening is arranged in particular on the pressure side and/or on the suction side of the blade.

This enables the aforementioned advantages to be combined with advantages of a favorable production or a production adapted in accordance with given requirements.

In addition, it is provided, in a technically advantageous embodiment of the impeller, that the fastening is formed in multiple parts, wherein either at least a first part of the fastening is formed between the blade and the bottom plate and at least a second part of the fastening is formed between the blade and the bead, or wherein at least a first part of the fastening is formed between the blade and the cover plate and at least a second part of the fastening is formed between the blade and the bead.

The blade can thus be advantageously attached to the bottom plate or the cover plate or the bead with particular stability and a greater flexibility in the production can thus be achieved.

In addition, it is provided, in a further technically advantageous embodiment of the impeller, that the blade is arranged between a pair of beads, wherein the pair of beads comprises a first bead and a second bead, wherein the first bead is formed on the cover plate and the second bead is formed on the bottom plate, wherein, in particular, the first bead and/or the second bead is/are formed according to any one of the preceding claims.

According to a further aspect, a technical object of the present disclosure is achieved by a radial fan comprising a housing, a motor, in particular a control unit, and an impeller for conveying a gaseous fluid, characterized in that the impeller is formed according to any one of the preceding claims.

This can also additionally improve flexibility during production and increase the strength.

Exemplary embodiments of the present disclosure are illustrated schematically in the figures and will be described in more detail below.

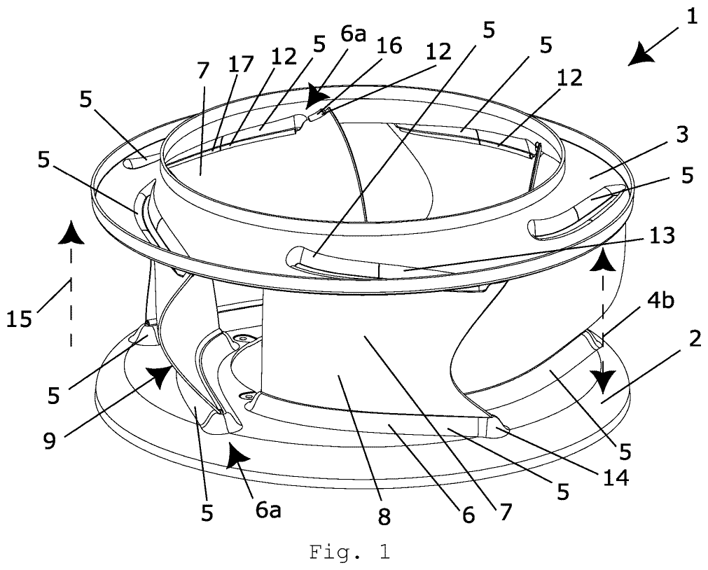

FIG. 1 is a perspective view of an impeller 1 of a radial fan for conveying a gaseous fluid, the impeller comprising a bottom plate 2, a cover plate 3, wherein the cover plate 3 is spaced apart from the bottom plate 2 in the axial direction of the impeller 1 and is arranged at a distance 4 between the bottom plate 2 and the cover plate 3, wherein the cover plate 3 and the bottom plate 2 have at least one impressed bead 5, in particular a plurality of impressed beads 5, a plurality of blades 7, wherein at least one blade 7 is arranged between the cover plate 3 and the bottom plate 2 and is fastened in the region of and over the profile of at least one bead 5, wherein a surface profile of the bead 5 follows a surface profile of the blade 7 fastened to the bead 5, at least in an envelope, such that a conveying effect of the bead 5 corresponds at least to a conveying effect of a blade surface 8 which is reduced because of the bead. The blade 7 can thereby be advantageously shortened and at the same time the bottom plate 2 and/or the cover plate 3 can be reinforced.

Furthermore, it is shown in FIG. 1 that the blade 7 is arranged on the bead 5. The bead 5 is impressed along a contour of the blade 9, in particular along a contour of an edge region of the blade that lies against the cover plate 3 or against the bottom plate 2. It is also shown that the bead 5, in particular a bead outlet 6a of the bead 5, has a continuously curved transition into the bottom plate 2 and into the cover plate. A fastening 12 of the blade 7 is illustrated by way of example as being formed by means of a welded connection, wherein the fastening 12 is illustrated arranged on the pressure side and on the suction side of the blade. FIG. 1 also shows by way of example that the blade 5 is arranged between a pair of beads (not denoted), wherein the pair of beads comprises a first bead 13 and a second bead 14, wherein the first bead 13 is formed on the cover plate 3 and the second bead 14 is formed on the bottom plate 2. In an advantageous manner, the impeller can thus be reinforced, and the lever ratios and stresses throughout the impeller are optimized.

In particular, forces introduced by the blades into the cover plate and/or bottom plate during operation can be advantageously reduced.

Furthermore, it is shown in FIG. 1 that the fastening 12 is formed in multiple parts, wherein a first part of the fastening 16 of the blade 7 is formed between blade 7 and cover plate 3 and at least a second part of the fastening 17 is formed between blade 7 and bead 5. The stability of the blade 7 at the cover plate 3 can thus be advantageously improved.

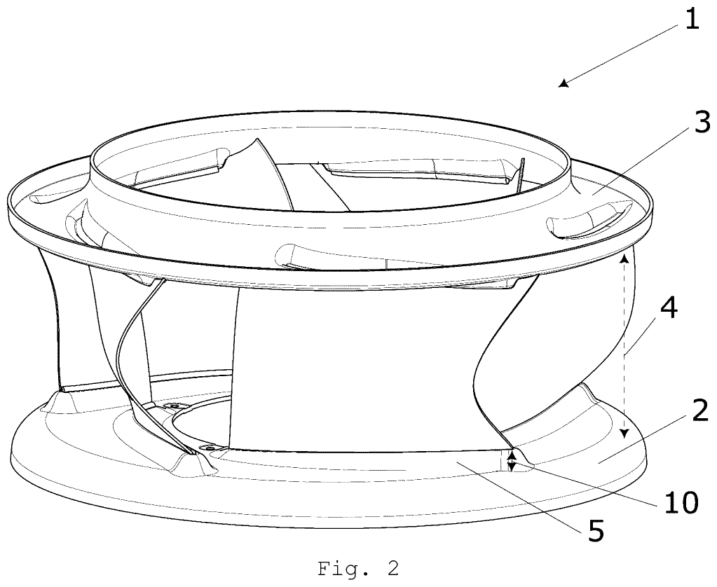

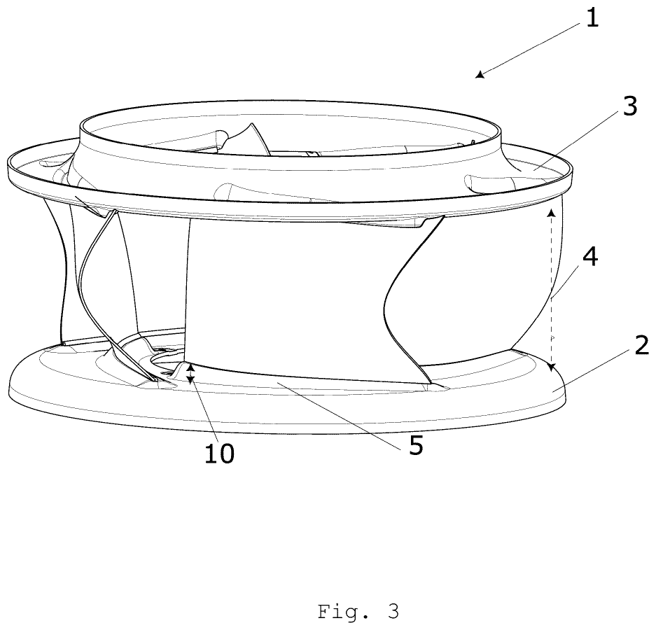

FIG. 2 shows a further perspective view of an impeller, analogously to FIG. 1. A height 10 of the bead 5 varies in the radial direction of the impeller and increases towards the outside. Analogously to FIGS. 1 and 2, FIG. 3 shows how the height 10 of the bead 5 decreases towards the outside. The height of the bead 5 corresponds here to a tenth, preferably an eighth, preferably a sixth, of the distance 4 between the bottom plate 2 and the cover plate 3. This means that higher velocities and higher rotational speeds can be advantageously achieved with the same conveying rate.

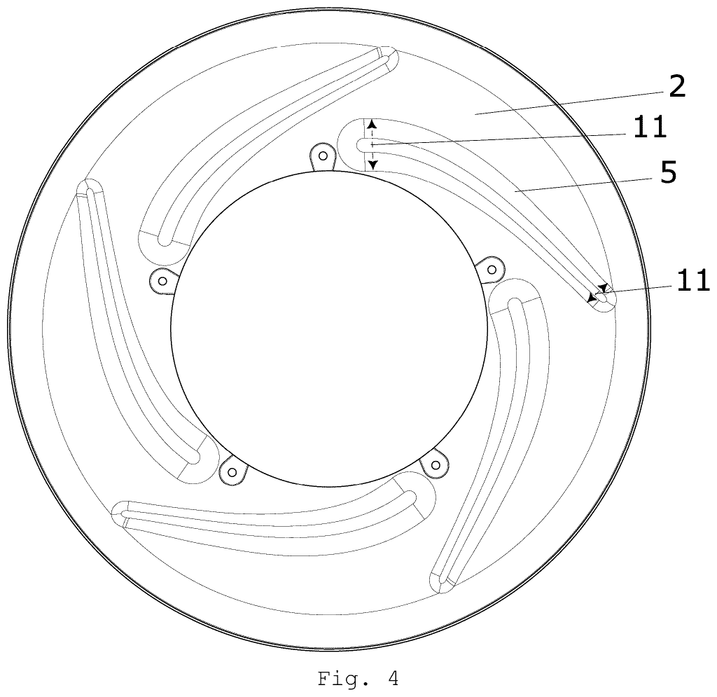

FIG. 4 shows, analogously to the other figures, a top view of a bottom plate 2 with beads 5. A width 11 of the bead 5 varies in the radial direction of the impeller and decreases towards the outside. It is furthermore illustrated that the bead 5 has a pressure-side profile, in particular a pressure-side contour profile, which deviates from a suction-side profile of the bead 5, in particular suction-side contour profile of the bead 5. It is also shown, in an overall view with the remaining figures, that the bead 5 is formed parallel or profiled to the blade 7 illustrated in FIGS. 1 to 3.

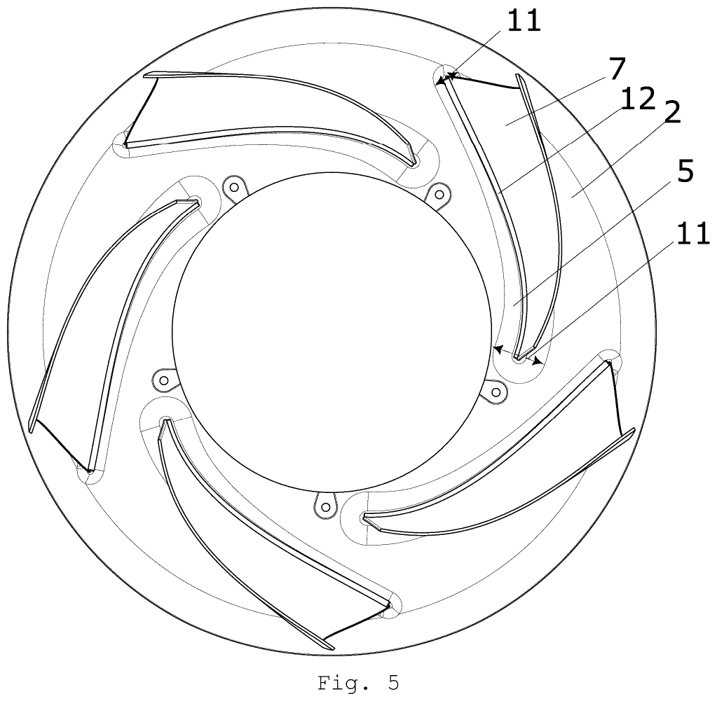

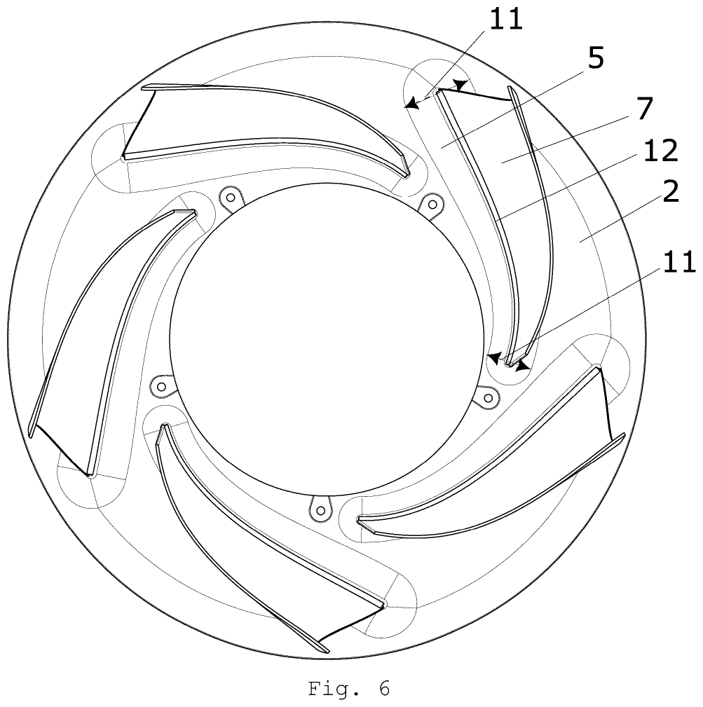

FIGS. 5 and 6, in an overall view with the remaining figures, both illustrate an axial top view of a bottom plate 2 with blades 7 arranged thereon by means of fastenings 12. The width 11 of the bead 5 decreases in FIG. 5 towards the radially outer edge of the bottom plate 2, thus towards the radially outer edge of the impeller 1 illustrated, for example, in FIG. 1. In contrast thereto, FIG. 6 illustrates the embodiment analogously to FIG. 5, in which the width 11 of the beads 5 decreases towards the edge, i.e. increases in a radial direction outwards. The abovementioned advantages will also be relevant here.

Although the present invention has been described with reference to preferred embodiments. workers skilled in the art will recognize that changes may be made in form and detail without departing from the spirit and scope of the invention.

### LIST OF REFERENCE SIGNS

1 Impeller
2 Bottom plate
3 Cover plate
4 Distance between bottom plate and cover plate
5 Beads
6 Bead surface
6a Bead outlet
7 Blade
8 Blade surface
9 Blade contour
10 Height of the bead
11 Width of the bead
12 Fastening of the blade
13 first bead
14 second bead
15 axial direction of the impeller
16 first part of the fastening
17 second part of the fastening

1. An impeller of a radial fan for conveying a gaseous fluid. the impeller comprising:
a bottom plate,
a cover plate,
wherein the cover plate is spaced apart from the bottom plate in an axial direction of the impeller,
wherein at least one of the cover plate or the bottom plate has at least one impressed bead,
a plurality of blades,
wherein at least one blade, of the plurality of blades, is arranged between the cover plate and the bottom plate and is fastened in a region of and over a profile of the at least one impressed bead,
wherein a surface profile of the at least one impressed bead follows a surface profile of the at least one blade fastened to the at least one impressed bead, at least in an envelope, such that a conveying effect of the at least one impressed bead corresponds at least to a conveying effect of a blade surface which is reduced because of the at least one impressed bead.

2. The impeller according to claim 1, wherein the at least one blade is arranged at the at least one impressed bead.

3. The impeller according to claim 1, wherein the at least one impressed bead is impressed along a contour of an edge region of the at least one blade that lies against the cover plate or against the bottom plate.

4. The impeller according to claim 1, wherein a height of the at least one impressed bead increases in a radial direction of the impeller.

5. The impeller according to claim 4, the height of the at least one impressed bead corresponds to a tenth of a distance between the bottom plate and the cover plate.

6. The impeller according to claim 1, wherein a width of the at least one impressed bead increases in a radial direction of the impeller.

7. The impeller according to claim 1, wherein the at least one impressed bead is only formed partially in a radial direction of the impeller.

8. The impeller according to claim 1, wherein a flank of the at least one impressed bead is formed parallel or profiled to the at least one blade.

9. The impeller according to claim 1, wherein the at least one impressed bead has a pressure-side contour profile, which deviates from a suction-side contour profile of the at least one impressed bead.

10. The impeller according to claim 1, wherein a bead outlet of the at least one impressed bead, has a continuously curved transition into the bottom plate and/or into the cover plate.

11. The impeller according to claim 1, wherein a fastening of the at least one blade is formed by a welded and/or a lashed and/or screwed and/or riveted and/or glued and/or calked connection, wherein the fastening is arranged on a pressure side and/or on a suction side of the at least one blade.

12. The impeller according to claim 11, wherein the fastening is formed in multiple parts,
wherein either
at least a first part of the fastening is formed between the at least one blade and the bottom plate and at least a second part of the fastening is formed between the at least one blade and the at least one impressed bead, or
at least a first part of the fastening is formed between the at least one blade and the cover plate and at least a second part of the fastening is formed between the at least one blade and the at least one impressed bead.

13. The impeller according to claim 1, wherein the at least one blade is arranged between a pair of beads,
wherein the pair of beads comprises a first bead and a second bead,
wherein the first bead is formed on the cover plate and the second bead is formed on the bottom plate.

14. A radial fan comprising a housing, a motor, a control unit, and an impeller for conveying a gaseous fluid, wherein the impeller comprising:
a bottom plate,
a cover plate,
wherein the cover plate is spaced apart from the bottom plate in an axial direction of the impeller
wherein at least one of the cover plate or the bottom plate has at least one impressed bead.
a plurality of blades, wherein at least one blade of the plurality of blades is arranged between the cover plate and the bottom plate and is fastened in a region of and over a profile of the at least one impressed bead.
wherein a surface profile of the at least one impressed bead follows a surface profile of the blade fastened to the at least one impressed bead. at least in an envelope such that a conveying effect of the at least one impressed bead corresponds at least to a conveying effect of a blade surface which is reduced because of the at least one impressed bead.

15. The radial fan according to claim 14, wherein the at least one of the cover plate or the bottom plate comprises a plurality of impressed beads.

16. The impeller according to claim 4, wherein the height of the at least one impressed bead corresponds to a twentieth of a distance between the bottom plate and the cover plate.

17. The impeller according to claim 1, wherein a flank of the at least one impressed bead is formed along a contour of the at least one blade.

18. The impeller according to claim 4, wherein the height of the at least one impressed bead corresponds to, at most, a fiftieth, of a distance between the bottom plate and the cover plate.

19. The impeller according to claim 1, wherein a bead outlet of the at least one impressed bead, has a partially curved transition into the bottom plate and/or into the cover plate.

20. The impeller according to claim 1, wherein the at least one of the cover plate or the bottom plate comprises a plurality of impressed heads.
